(19) United States
(12) Patent Application Publication
(10) Pub. No.: US 2020/0304998 A1
(43) Pub. Date: Sep. 24, 2020

(54) INFORMATION PROCESSING APPARATUS THAT OUTPUTS PASSWORD, AUTHENTICATION METHOD

(71) Applicant: KYOCERA Document Solutions Inc., Osaka (JP)

(72) Inventor: Koichiro Tazuke, Osaka (JP)

(21) Appl. No.: 16/823,796

(22) Filed: Mar. 19, 2020

(30) Foreign Application Priority Data
Mar. 22, 2019 (JP) 2019-055462

(51) Int. Cl. H04W 12/06; H04L 29/06; H04L 9/32

(52) U.S. Cl. CPC H04W 12/0608; H04L 9/3228; H04L 63/0846

(57) ABSTRACT

An information processing apparatus includes a generation processing portion, a presentation processing portion, and an authentication processing portion. The generation processing portion generates a password. The presentation processing portion presents, in such a way as not to pass through an external device, the password generated by the generation processing portion to a mobile terminal associated with an authentication-target user. The authentication processing portion authenticates the user when the password is input after the password is generated by the generation processing portion.

### INCORPORATION BY REFERENCE

This application is based upon and claims the benefit of priority from the corresponding Japanese Patent Application No. 2019-055462 filed on Mar. 22, 2019, the entire contents of which are incorporated herein by reference.

### BACKGROUND

The present disclosure relates to an information processing apparatus and an authentication method.

There is known an information processing apparatus such as a multifunction peripheral that performs authentication of a user based on an authentication operation such as an input of a user ID or a password. In addition, there is known, as a related technology, an information processing apparatus that performs authentication of a user by using a password called “one-time password” that can be used only once. Specifically, in this information processing apparatus, a one-time password is generated and sent to an e-mail address associated with an authentication-target user. Thereafter, when a password input by the user matches the one-time password that has been sent in advance, the user is authenticated.

### SUMMARY

An information processing apparatus according to an aspect of the present disclosure includes a generation processing portion, a presentation processing portion, and an authentication processing portion. The generation processing portion generates a password. The presentation processing portion presents, in such a way as not to pass through an external device, the password generated by the generation processing portion to a mobile terminal associated with an authentication-target user. The authentication processing portion authenticates the user when the password is input after the password is generated by the generation processing portion.

An authentication method according to another aspect of the present disclosure is executed by a processor included in an information processing apparatus, and includes a generation step, a presentation step, and an authentication step. In the generation step, a password is generated. In the presentation step, the password generated in the generation step is presented, in such a way as not to pass through an external device, to a mobile terminal associated with an authentication-target user. In the authentication step, the user is authenticated when the password is input after the password is generated in the generation step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image processing system according to a first embodiment of the present disclosure.

FIG. 2 is a diagram showing a configuration of an image processing apparatus included in the image processing system according to the first embodiment of the present disclosure.

FIG. 3 is a flowchart showing an example of a first authentication process executed by the image processing apparatus included in the image processing system according to the first embodiment of the present disclosure.

FIG. 4 is a flowchart showing an example of a first main authentication process executed by the image processing apparatus included in the image processing system according to the first embodiment of the present disclosure.

FIG. 5 is a block diagram showing a configuration of an image processing system according to a second embodiment of the present disclosure.

FIG. 6 is a flowchart showing an example of a second authentication process executed by an image processing apparatus included in the image processing system according to the second embodiment of the present disclosure.

FIG. 7 is a flowchart showing an example of a second main authentication process executed by the image processing apparatus included in the image processing system according to the second embodiment of the present disclosure.

### DETAILED DESCRIPTION

The following describes embodiments of the present disclosure with reference to the accompanying drawings. It should be noted that the following embodiments are examples of specific embodiments of the present disclosure and should not limit the technical scope of the present disclosure.

### First Embodiment

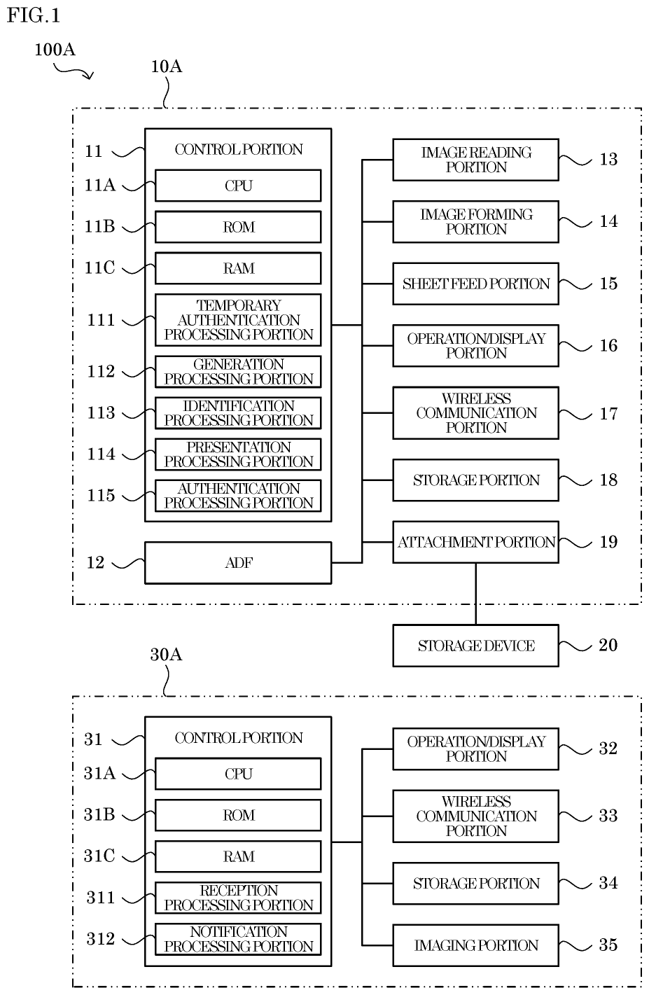

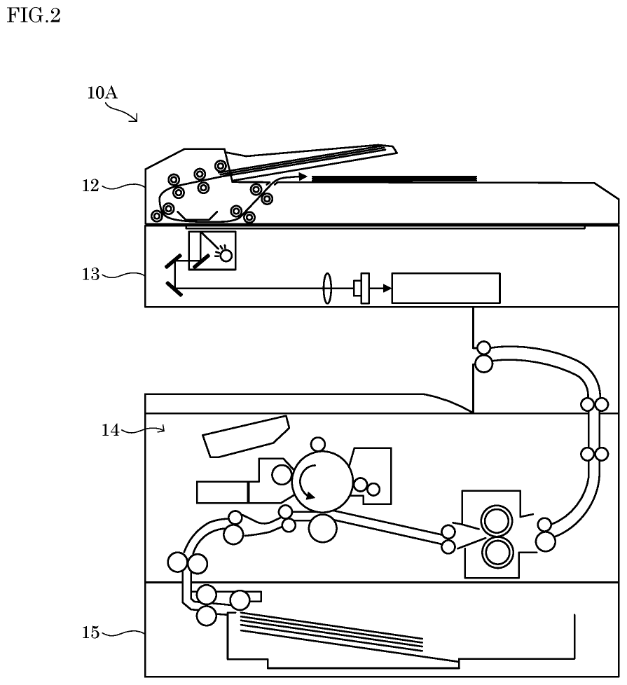

First, a description is given of a configuration of an image processing system 100A according to a first embodiment of the present disclosure with reference to FIG. 1 and FIG. 2.

The image processing system 100A includes an image processing apparatus 10A shown in FIG. 1 and one or more mobile terminals 30A shown in FIG. 1. It is noted that in FIG. 1, the image processing apparatus 10A and the mobile terminals 30A are indicated by two-dot chain lines.

In the image processing system 100A, the image processing apparatus 10A and the mobile terminals 30A are configured to perform a short range wireless communication conforming to a predetermined communication standard. For example, the communication standard is NFC (Near Field Communication). It is noted that the communication standard may be Bluetooth.

[Image Processing Apparatus 10A]

The image processing apparatus 10A is a multifunction peripheral having a plurality of functions such as a scan function for reading image data from a document sheet, a print function for forming an image based on image data, a facsimile function, and a copy function. Here, the image processing apparatus 10A is an example of an information processing apparatus of the present disclosure. It is noted that the present disclosure is applicable to information processing apparatuses such as a scanner, a printer, a facsimile device, a copier, and a personal computer.

As shown in FIG. 1 and FIG. 2, the image processing apparatus 10A includes a control portion 11, an ADF (Automatic Document Feeder) 12, an image reading portion 13, an image forming portion 14, a sheet feed portion 15, an operation/display portion 16 (an example of a display portion of the present disclosure), a wireless communication portion 17, a storage portion 18, and an attachment portion 19.

The control portion 11 includes control equipment such as a CPU 11A, a ROM 11B, and a RAM 11C. The CPU 11A is a processor that executes various calculation processes. The ROM 11B is a nonvolatile storage device in which various information such as control programs for causing the CPU 11A to execute various processes are preliminarily stored. The RAM 11C is a volatile storage device that is used as a temporary storage memory (working area) for the various processes executed by the CPU 11A. In the control portion 11, the CPU 11A executes the various control programs stored in advance in the ROM 11B. This allows the image processing apparatus 10A to be controlled comprehensively by the control portion 11. It is noted that the control portion 11 may be formed as an electronic circuit such as an integrated circuit (ASIC), and may be a control portion provided independently of a main control portion that comprehensively controls the image processing apparatus 10A.

The ADF 1 includes a document sheet setting portion, a plurality of conveyance rollers, a document sheet pressing, and a sheet discharge portion, and conveys a document sheet so that it is read by the image reading portion 13.

The image reading portion 13 includes a document sheet table, a light source, a plurality of mirrors, an optical lens, and a CCD, and is configured to read image data from a document sheet.

The image forming portion 14 is configured to form an image on a sheet by an electrophotographic method based on image data read by the image reading portion 13. In addition, the image forming portion 14 is configured to form an image on a sheet based on image data input from an external information processing apparatus such as a personal computer. Specifically, the image forming portion 14 includes a photoconductor drum, a charging device, a laser scanning unit (LSU), a developing device, a transfer roller, a cleaning device, a fixing device, and a sheet discharge tray. It is noted that the image forming portion 14 may form an image by another image forming method such as an inkjet method.

The sheet feed portion 15 includes a sheet feed cassette and a plurality of conveyance rollers, and supplies sheets one by one to the image forming portion 14. The image forming portion 14 forms an image on a sheet supplied from the sheet feed portion 15, based on the image data.

The operation/display portion 16 includes a display portion and an operation portion. The display portion is, for example, a liquid crystal display and displays various types of information in response to control instructions from the control portion 11. The operation portion is composed of, for example, operation keys or a touch panel through which various types of information are input to the control portion 11 in response to user operations.

The wireless communication portion 17 is a communication interface configured to perform a wireless data communication with external communication apparatuses such as the mobile terminals 30A. For example, the wireless communication portion 17 performs the short range wireless communication with the mobile terminals 30A in accordance with communication protocols defined by NFC. Specifically, the wireless communication portion 17 is configured to perform an NFC wireless communication using a frequency band of 13.56 MHz, with a mobile terminal(s) 30A that is present within a communication range of approximately 10 cm from the image processing apparatus 10A. It is noted that the NFC data communication method is well known conventionally, and description thereof is omitted here. It is noted that the wireless communication portion 17 may perform a Bluetooth wireless communication with the mobile terminals 30A.

The storage portion 18 is a nonvolatile storage device. For example, the storage portion 18 is a storage device such as a nonvolatile memory, a SSD (Solid State Drive), or a HDD (Hard Disk Drive), wherein the nonvolatile memory is, for example, a flash memory or an EEPROM.

The attachment portion 19 includes a USB connection terminal to which an external electronic device with which data input and output based on a USB standard is possible, is attached in a detachable manner. For example, a storage device 20 (see FIG. 1) with which writing and reading data based on a USB standard is possible, is attached to the attachment portion 19 in a detachable manner. For example, the storage device 20 is a USB memory.

Users who use the image processing apparatus 10A are preliminarily registered in the image processing apparatus 10A. Specifically, the storage portion 18 of the image processing apparatus 10A preliminarily stores a plurality of pieces of authentication information that respectively correspond to the users. The authentication information is used when the image processing apparatus 10A performs authentication of a user. For example, each piece of authentication information includes a user name and a password.

[Mobile Terminal 30A]

The mobile terminals 30A are smartphones owned by the users. It is noted that the mobile terminals 30A may be tablet terminals, mobile phones, PDAs, or notebook computers.

As shown in FIG. 1, each of the mobile terminals 30A includes a control portion 31, an operation/display portion 32, a wireless communication portion 33, a storage portion 34, and an imaging portion 35.

Similar to the control portion 11 of the image processing apparatus 10A, the control portion 31 includes control equipment such as a CPU 31A, a ROM 31B, and a RAM 31C. It is noted that the control portion 31 may be formed as an electronic circuit such as an integrated circuit (ASIC), and may be a control portion provided independently of a main control portion that comprehensively controls the mobile terminal 30A.

Similar to the operation/display portion 16 of the image processing apparatus 10A, the operation/display portion 32 includes a display portion and an operation portion, wherein the display portion is, for example, a liquid crystal display, and the operation portion is, for example, operation keys or a touch panel.

Similar to the wireless communication portion 17 of the image processing apparatus 10A, the wireless communication portion 33 is a communication interface configured to perform a wireless data communication with external communication apparatuses such as the image processing apparatus 10A.

Similar to the storage portion 18 of the image processing apparatus 10A, the storage portion 34 is a nonvolatile storage device.

The imaging portion 35 is a camera configured to photograph an object. Specifically, the imaging portion 35 is configured to output an electric signal (image data) based on light received from outside.

The mobile terminals 30A owned by the users are preliminarily registered in the image processing apparatus 10A. Specifically, the storage portion 18 of the image processing apparatus 10A preliminarily stores a plurality of pieces of terminal identification information of the mobile terminals 30A respectively corresponding to the users, in association with the plurality of pieces of authentication information of the users. For example, the plurality of pieces of terminal identification information are MAC addresses assigned to the wireless communication portions 33.

Meanwhile, there is known, as a related technology, an information processing apparatus that performs authentication of a user by using a password called “one-time password” that can be used only once. Specifically, in this information processing apparatus, a one-time password is generated and sent to an e-mail address associated with an authentication-target user. Thereafter, when a password input by the user matches the one-time password that has been sent in advance, the user is authenticated.

However, in a case where, as in the above-described related technology, the one-time password is sent to an e-mail address associated with an authentication-target user, there is a possibility that the confidentiality of the one-time password is decreased by eavesdropping during the mail transfer.

On the other hand, the image processing system 100A according to a first embodiment of the present disclosure is configured to present a password for use in the authentication to an authentication-target user without decreasing the confidentiality.

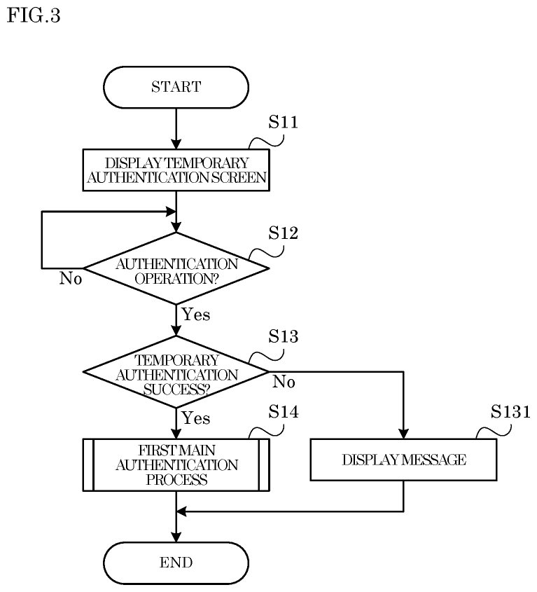

Specifically, the storage portion 18 of the image processing apparatus 10A preliminarily stores a first authentication program that causes the CPU 11A of the control portion 11 to execute a first authentication process (see the flowchart of FIG. 3) that is described below. It is noted that the first authentication program may be recorded on a non-transitory computer-readable recording medium such as a CD, a DVD, or a flash memory, and may be read from the recording medium and installed in the storage portion 18.

As shown in FIG. 1, the control portion 11 includes a temporary authentication processing portion 111, a generation processing portion 112, an identification processing portion 113, a presentation processing portion 114, and an authentication processing portion 115. Specifically, the control portion 11 executes the first authentication program stored in the storage portion 18 by using the CPU 11A. This allows the control portion 11 to function as the temporary authentication processing portion 111, the generation processing portion 112, the identification processing portion 113, the presentation processing portion 114, and the authentication processing portion 115.

The temporary authentication processing portion 111 performs temporary authentication of a user based on a predetermined authentication operation.

Specifically, the authentication operation is an attachment of the storage device 20 to the attachment portion 19. When the authentication operation has been performed, namely, when the storage device 20 has been attached to the attachment portion 19, the temporary authentication processing portion 111 reads data from the storage device 20. Furthermore, when the read data includes any one of the plurality of pieces of authentication information stored in the storage portion 18, the temporary authentication processing portion 111 temporarily authenticates a user corresponding to the piece of authentication information. That is, the temporary authentication processing portion 111 temporarily determines that the operator of the image processing apparatus 10A is identical to the authentication-target user, namely, identical to the user corresponding to the piece of authentication information read from the storage device 20.

It is noted that the authentication operation may be an input of a user name and a password. In addition, the temporary authentication processing portion 111 may perform a temporary authentication of a user by a biological authentication such as a fingerprint authentication, a voiceprint authentication, or an iris authentication.

The generation processing portion 112 generates a password after the temporary authentication processing portion 111 temporarily authenticates a user.

For example, the generation processing portion 112 generates, by using a random number, a password composed of a predetermined number of characters that include one or more letters, numerals, or signs.

The identification processing portion 113 controls the wireless communication portion 17 to identify a mobile terminal 30A that is within the communication range of the short range wireless communication and that corresponds to the user temporarily authenticated by the temporary authentication processing portion 111. It is noted that hereinafter, the mobile terminal 30A that corresponds to the user temporarily authenticated by the temporary authentication processing portion 111, is referred to as a “specific mobile terminal”.

The presentation processing portion 114 presents, in such a way as not to pass through an external device, the password generated by the generation processing portion 112 to the specific mobile terminal identified by the identification processing portion 113. In other words, the presentation processing portion 114 presents the password generated by the generation processing portion 112 directly to the specific mobile terminal identified by the identification processing portion 113. Here, the external device is a communication device, such as a router or an access point, that is provided in a data transfer path in a wired or wireless communication network.

Specifically, the presentation processing portion 114 controls the wireless communication portion 17 to transmit the password generated by the generation processing portion 112 to the specific mobile terminal identified by the identification processing portion 113.

The authentication processing portion 115 authenticates the user who has been temporarily authenticated by the temporary authentication processing portion 111 when a password is input after the password is generated by the generation processing portion 112. That is, the authentication processing portion 115 determines that the operator of the image processing apparatus 10A is identical to the authentication-target user.

Specifically, the authentication processing portion 115 authenticates the user who has been temporarily authenticated by the temporary authentication processing portion 111 when the password generated by the generation processing portion 112 is input before a predetermined allowable time elapses since the generation of the password. For example, the allowable time is an arbitrarily determined time period between one minute and 10 minutes.

It is noted that the authentication processing portion 115 may authenticate the user who has been temporarily authenticated by the temporary authentication processing portion 111 when the password generated by the generation processing portion 112 is input before a next password is generated.

The storage portion 34 of each of the mobile terminals 30A preliminarily stores a first application program corresponding to the first authentication program. It is noted that the first application program may be downloaded from an external server and installed in the storage portion 34.

As shown in FIG. 1, the control portion 31 of each mobile terminal 30A includes a reception processing portion 311 and a notification processing portion 312. Specifically, the control portion 31 causes the CPU 31A to execute the first application program stored in the storage portion 34. This allows the control portion 31 to function as the reception processing portion 311 and the notification processing portion 312.

The reception processing portion 311 receives a password transmitted by the presentation processing portion 114.

The notification processing portion 312 notifies the password received by the reception processing portion 311. For example, the notification processing portion 312 displays the received password on the operation/display portion 32.

[First Authentication Process]

In the following, with reference to FIG. 3, a description is given of an example of the procedure of the first authentication process executed by the control portion 11 of the image processing apparatus 10A in the image processing system 100A, and an example of the procedure of an authentication method of the present disclosure. Here, steps S11, S12, . . . represent numbers assigned to the processing procedures (steps) executed by the control portion 11. It is noted that the first authentication process is executed in response to a predetermined operation performed on the operation/display portion 16.

<Step S11>

First, in step S11, the control portion 11 displays, on the operation/display portion 16, a temporary authentication screen for receiving the authentication operation.

For example, the temporary authentication screen includes a message that urges an attachment of the storage device 20 to the attachment portion 19.

<Step S12>

In step S12, the control portion 11 determines whether or not the authentication operation has been performed.

Specifically, when an attachment of the storage device 20 to the attachment portion 19 is detected, the control portion 11 determines that the authentication operation has been performed.

Here, upon determining that the authentication operation has been performed (Yes side at S12), the control portion 11 moves the process to step S13. In addition, upon determining that the authentication operation has not been performed (No side at S12), the control portion 11 waits at step S12 for the authentication operation to be performed.

<Step S13>

In step S13, the control portion 11 determines whether or not the temporary authentication of the authentication-target user has succeeded. Here, the process of step S13 is executed by the temporary authentication processing portion 111 of the control portion 11.

Specifically, in a case where data read from the storage device 20 attached to the attachment portion 19 includes a piece of authentication information that is any one of the plurality of pieces of authentication information stored in the storage portion 18, the control portion 11 determines that a temporary authentication of a user corresponding to the piece of authentication information (an authentication-target user) has succeeded. On the other hand, in a case where the data read from the storage device 20 attached to the attachment portion 19 does not include any one of the plurality of pieces of authentication information stored in the storage portion 18, the control portion 11 determines that the temporary authentication of the user has failed.

Here, upon determining that the temporary authentication of the user has succeeded (Yes side at S13), the control portion 11 moves the process to step S14. In addition, upon determining that the temporary authentication of the user has failed (No side at S13), the control portion 11 moves the process to step S131.

<Step S131>

In step S131, the control portion 11 displays, on the operation/display portion 16, a message indicating that the user authentication has failed.

<Step S14>

In step S14, the control portion 11 executes a first main authentication process that is described below.

It is noted that processes of steps S11 to S13 and step S131 may be omitted. In this case, the control portion 11 may not include the temporary authentication processing portion 111.

[First Main Authentication Process]

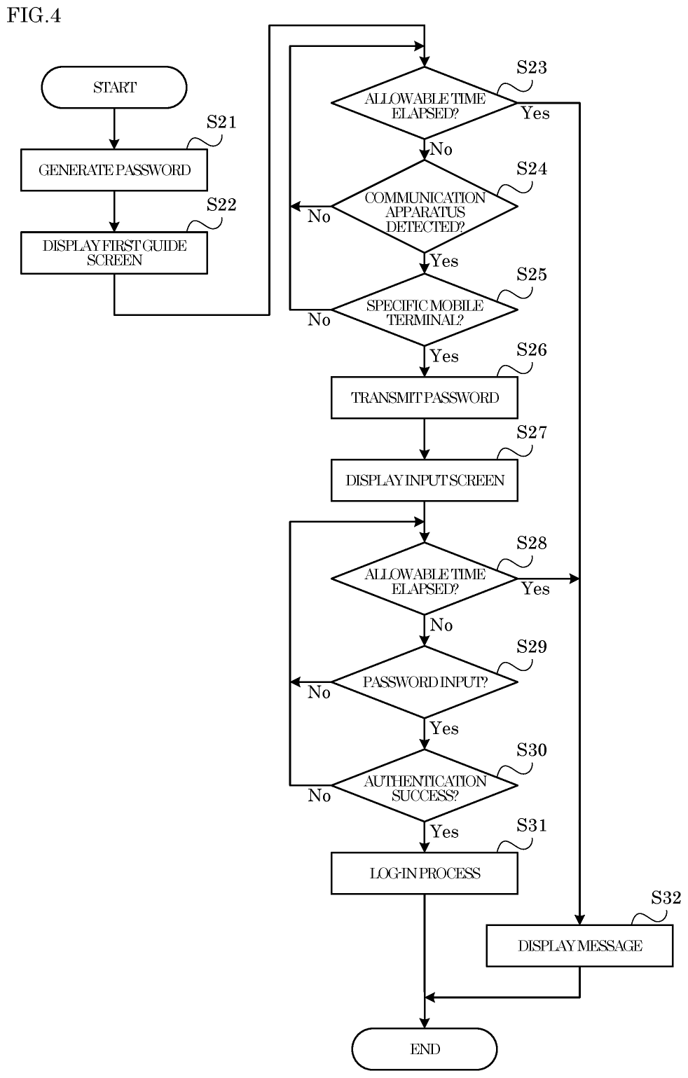

Next, a description is given of the first main authentication process executed in step S14 of the first authentication process, with reference to FIG. 4.

<Step S21>

First, in step S21, the control portion 11 generates a password. Here, the process of step S21 is an example of a generation step of the present disclosure and is executed by the generation processing portion 112 of the control portion 11.

<Step S22>

In step S22, the control portion 11 displays a first guide screen that urges the operator of the image processing apparatus 10A to perform a certain operation.

For example, the first guide screen includes a message urging to hold the mobile terminal 30A over a predetermined position on the image processing apparatus 10A. In addition, the first guide screen includes an elapsed time from the execution of the process of step S21, and the allowable time.

<Step S23>

In step S23, the control portion 11 determines whether or not the allowable time has elapsed since the execution of the process of step S21.

Here, upon determining that the allowable time has elapsed (Yes side at S23), the control portion 11 moves the process to step S32. In addition, upon determining that the allowable time has not elapsed (No side at S23), the control portion 11 moves the process to step S24.

<Step S24>

In step S24, the control portion 11 determines whether or not a communication apparatus that can perform the short range wireless communication has been detected within a communication range of the short range wireless communication.

Here, upon determining that a communication apparatus that can perform the short range wireless communication has been detected (Yes side at S24), the control portion 11 moves the process to step S25. In addition, upon determining that a communication apparatus that can perform the short range wireless communication has not been detected (No side at S24), the control portion 11 moves the process to step S23.

<Step S25>

In step S25, the control portion 11 determines whether or not the communication apparatus detected in step S24 is the specific mobile terminal. Here, processes of steps S24 and S25 are executed by the identification processing portion 113 of the control portion 11.

Here, upon determining that the communication apparatus detected in step S24 is the specific mobile terminal (Yes side at S25), the control portion 11 moves the process to step S26. In addition, upon determining that the communication apparatus detected in step S24 is not the specific mobile terminal (No side at S25), the control portion 11 moves the process to step S23.

<Step S26>

In step S26, the control portion 11 transmits the password generated in step S21 to the specific mobile terminal detected in step S24. Here, the process of step S26 is an example of a presentation step of the present disclosure and is executed by the presentation processing portion 114 of the control portion 11.

<Step S27>

In step S27, the control portion 11 displays, on the operation/display portion 16, an input screen for inputing a password.

<Step S28>

In step S28, the control portion 11 determines whether or not the allowable time has elapsed since the execution of the process of step S21.

Here, upon determining that the allowable time has elapsed (Yes side at S28), the control portion 11 moves the process to step S32. In addition, upon determining that the allowable time has not elapsed (No side at S28), the control portion 11 moves the process to step S29.

<Step S29>

In step S29, the control portion 11 determines whether or not a password has been input on the input screen displayed in step S27.

Here, upon determining that a password has been input (Yes side at S29), the control portion 11 moves the process to step S30. In addition, upon determining that a password has not been input (No side at S29), the control portion 11 moves the process to step S28.

<Step S30>

In step S30, the control portion 11 determines whether or not the authentication of the authentication-target user has succeeded. Here, the process of step S30 is an example of an authentication step of the present disclosure and is executed by the authentication processing portion 115 of the control portion 11.

Specifically, in a case where the password that was input on the input screen matches the password generated in step S21, the control portion 11 determines that the authentication of the authentication-target user has succeeded. On the other hand, in a case where the password that was input on the input screen does not match the password generated in step S21, the control portion 11 determines that the authentication of the authentication-target user has failed.

Here, upon determining that the authentication of the authentication-target user has succeeded (Yes side at S30), the control portion 11 moves the process to step S31. In addition, upon determining that the authentication of the authentication-target user has failed (No side at S30), the control portion 11 moves the process to step S28.

<Step S31>

In step S31, the control portion 11 executes a log-in process to allow the authentication-target user, namely, the user corresponding to the piece of authentication information read from the storage device 20, to log in the image processing apparatus 10A.

For example, the control portion 11 displays, on the operation/display portion 16, an operation screen corresponding to the authenticated user.

<Step S32>

In step S32, the control portion 11 displays, on the operation/display portion 16, a message indicating that the user authentication has failed.

As described above, in the image processing system 100A, the password generated by the generation processing portion 112 is transmitted directly to the specific mobile terminal identified by the identification processing portion 113. With this configuration, it is possible to present a password for use in authentication to an authentication-target user without decreasing the confidentiality.

### Second Embodiment

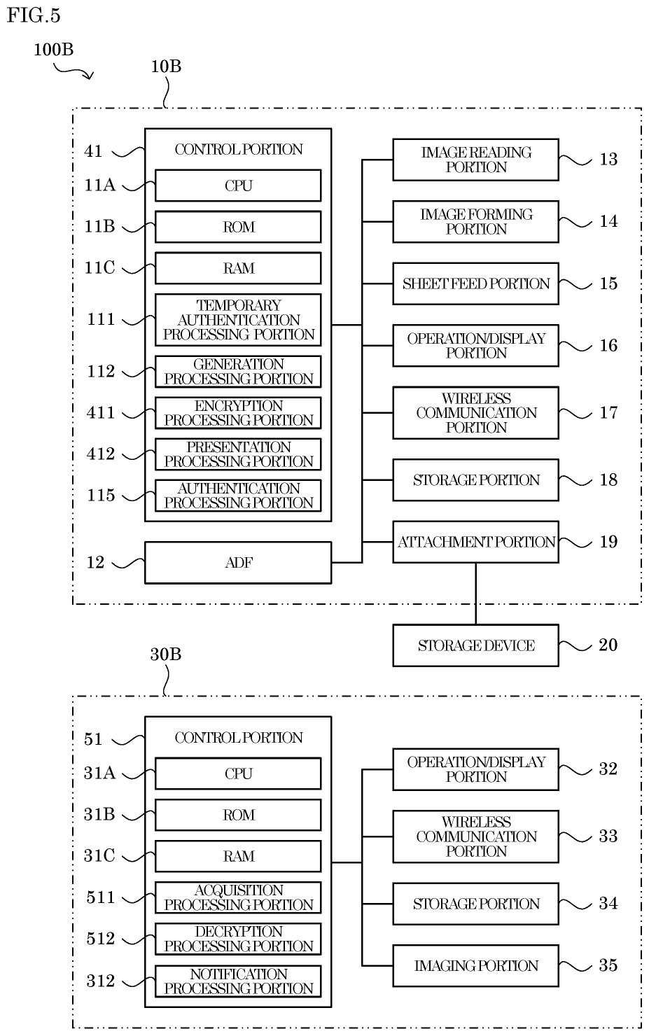

Next, a description is given of a configuration of an image processing system 100B according to a second embodiment of the present disclosure with reference to FIG. 5.

The image processing system 100B includes an image processing apparatus 10B shown in FIG. 5, and one or more mobile terminals 30B shown in FIG. 5. It is noted that in FIG. 5, components of the image processing system 100B that are the same as those of the image processing system 100A are assigned the same reference signs. The following describes only components that are different from those of the image processing system 100A.

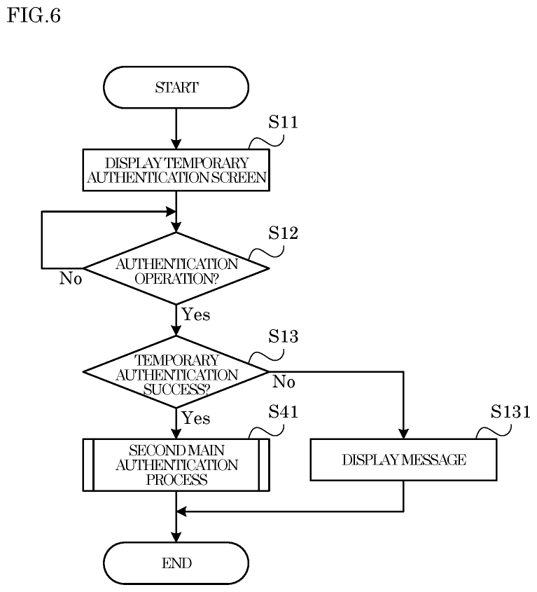

The image processing apparatus 10B includes a control portion 41 in place of the control portion 11. The control portion 41 differs from the control portion 11 in that it includes an encryption processing portion 411 and a presentation processing portion 412 in place of the identification processing portion 113 and the presentation processing portion 114. In the image processing apparatus 10B, the storage portion 18 preliminarily stores a second authentication program that corresponds to a second authentication process (see the flowchart of FIG. 6) that is described below. The control portion 41 executes the second authentication program stored in the storage portion 18 by using the CPU 11A. This allows the control portion 41 to function as the temporary authentication processing portion 111, the generation processing portion 112, the encryption processing portion 411, the presentation processing portion 412, and the authentication processing portion 115. Here, the image processing apparatus 10B is another example of the information processing apparatus of the present disclosure.

The encryption processing portion 411 encrypts the password generated by the generation processing portion 112, by using an encryption key associated with the authentication-target user.

Specifically, in the image processing apparatus 10B, a plurality of encryption keys respectively corresponding to the users are stored in the storage portion 18 in association with the plurality of pieces of authentication information that respectively correspond to the users.

The encryption processing portion 411 encrypts the password generated by the generation processing portion 112, by using an encryption key associated with the piece of authentication information that corresponds to the user temporarily authenticated by the temporary authentication processing portion 111.

The presentation processing portion 412 presents, in such a way as not to pass through the external device, the password generated by the generation processing portion 112 to the specific mobile terminal. Specifically, the presentation processing portion 412 displays, on the operation/display portion 16, the password encrypted by the encryption processing portion 411. That is, the presentation processing portion 412 presents the password generated by the generation processing portion 112 to the specific mobile terminal in such a way that only the specific mobile terminal can receive it, namely, the presentation processing portion 412 presents, to the specific mobile terminal, the password that has been encrypted in such a way that only the specific mobile terminal can decipher it.

For example, the presentation processing portion 412 encodes the password encrypted by the encryption processing portion 411, into a predetermined information code, and displays, on the operation/display portion 16, the information code acquired by the encoding. For example, the information code is a two-dimensional code such as a QR code, or a one-dimensional code such as a bar code.

Each of the mobile terminals 30A includes a control portion 51 in place of the control portion 31. The control portion 51 differs from the control portion 31 in that it includes an acquisition processing portion 511 and a decryption processing portion 512 in place of the reception processing portion 311. The storage portion 34 of each of the mobile terminals 30B preliminarily stores a second application program corresponding to the second authentication program. The control portion 51 causes the CPU 31A to execute the second application program stored in the storage portion 34. This allows the control portion 51 to function as the acquisition processing portion 511, the decryption processing portion 512, and the notification processing portion 312.

The acquisition processing portion 511 controls the imaging portion 35 to photograph the information code displayed on the operation/display portion 16 by the presentation processing portion 412.

The decryption processing portion 512 decrypts the encrypted password included in the information code photographed by the acquisition processing portion 511, by using a decryption key paired with the encryption key corresponding to a piece of terminal identification information of a mobile terminal 30B.

For example, when a piece of terminal identification information of a mobile terminal 30B is to be registered, the control portion 41 of the image processing apparatus 10B generates an encryption key and a decryption key paired with the encryption key. In addition, the control portion 41 stores the piece of terminal identification information of the mobile terminal 30B and the generated encryption key in the storage portion 18 in association with a piece of authentication information corresponding to a user who owns the mobile terminal 30B. Furthermore, the control portion 41 transmits the generated decryption key to the mobile terminal 30B. The control portion 51 of the mobile terminal 30B stores, in the storage portion 34, the decryption key received from the image processing apparatus 10B.

[Second Authentication Process]

In the following, with reference to FIG. 6, a description is given of an example of the procedure of the second authentication process executed by the control portion 41 of the image processing apparatus 10B in the image processing system 100B, and another example of the procedure of the authentication method of the present disclosure. It is noted that in FIG. 6, processes that are common with those of the first authentication process are assigned the same reference signs. The following describes only processes that are different from those of the first authentication process.

<Step S41>

First, in step S41, the control portion 41 executes a second main authentication process that is described below.

[Second Main Authentication Process]

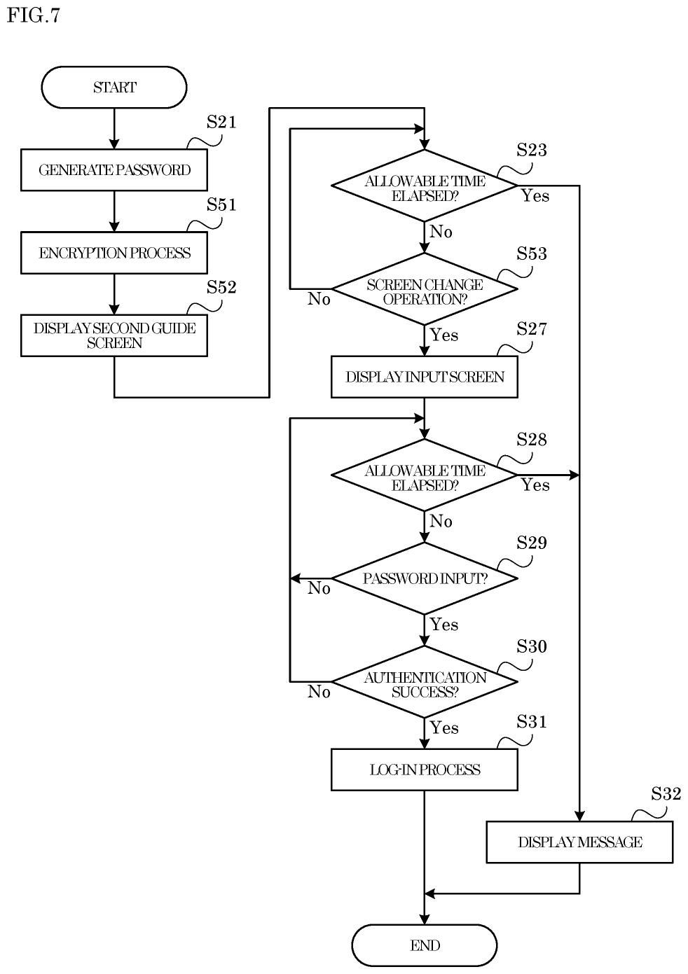

Next, a description is given of the second main authentication process executed in step S41 of the second authentication process, with reference to FIG. 7. It is noted that in FIG. 7, processes that are common with those of the first main authentication process are assigned the same reference signs. The following describes only processes that are different from those of the first main authentication process.

<Step S51>

In step S51, the control portion 41 encrypts the password generated in step S21, by using an encryption key associated with the authentication-target user. Here, the process of step S51 is executed by the encryption processing portion 411 of the control portion 41.

<Step S52>

In step S52, the control portion 41 displays a second guide screen including the information code. Here, the process of step S52 is another example of the presentation step of the present disclosure and is executed by the presentation processing portion 412 of the control portion 41.

For example, the second guide screen includes the information code and a message urging to photograph this encoded image by using the mobile terminal 30B. In addition, the second guide screen includes an elapsed time from the execution of the process of step S21, and the allowable time.

Specifically, the control portion 41 encodes the password encrypted in step S51 into the information code, and displays, on the operation/display portion 16, the second guide screen that includes the information code acquired by the encoding.

<Step S53>

In step S53, the control portion 41 determines whether or not a predetermined screen change operation has been performed on the second guide screen. For example, the screen change operation is an operation of a predetermined operation icon displayed on the second guide screen.

Here, upon determining that the screen change operation has been performed (Yes side at S53), the control portion 41 moves the process to step S27. In addition, upon determining that the screen change operation has not been performed (No side at S53), the control portion 41 moves the process to step S23.

As described above, in the image processing system 100B, a password generated by the generation processing portion 112 is encrypted with an encryption key associated with an authentication-target user, and the encrypted password is displayed. This makes it possible to convey a password only to a mobile terminal 30B that has a decryption key corresponding to the encryption key. It is thus possible to present a password for use in the authentication without decreasing the confidentiality.

It is noted that the image processing apparatus 10A may include the encryption processing portion 411 and the presentation processing portion 412. In this case, in the image processing apparatus 10A, it may be possible to set for each user which of the first authentication process and the second authentication process is to be executed.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus comprising:
a generation processing portion configured to generate a password;
a presentation processing portion configured to present, in such a way as not to pass through an external device, the password generated by the generation processing portion to a mobile terminal associated with an authentication-target user; and
an authentication processing portion configured to authenticate the user when the password is input after the password is generated by the generation processing portion.

2. The information processing apparatus according to claim 1, wherein
the authentication processing portion authenticates the user when the password generated by the generation processing portion is input before a predetermined allowable time elapses since a generation of the password.

3. The information processing apparatus according to claim 1, further comprising:
a wireless communication portion configured to perform a predetermined wireless communication with an external communication apparatus; and
an identification processing portion configured to control the wireless communication portion to identify a mobile terminal that is present within a communication range of the wireless communication, wherein
the presentation processing portion controls the wireless communication portion to transmit the password generated by the generation processing portion to the mobile terminal identified by the identification processing portion.

4. The information processing apparatus according to claim 1, further comprising:
a display portion; and
an encryption processing portion configured to encrypt the password generated by the generation processing portion, by using an encryption key associated with the user, wherein
the presentation processing portion displays, on the display portion, the password encrypted by the encryption processing portion.

5. The information processing apparatus according to claim 1, further comprising:
a temporary authentication processing portion configured to perform temporary authentication of a user based on a predetermined authentication operation, wherein
the generation processing portion generates the password after the temporary authentication processing portion temporarily authenticates the user.

6. An authentication method executed by a processor included in an information processing apparatus, the authentication method comprising:
a generation step of generating a password;
a presentation step of presenting, in such a way as not to pass through an external device, the password generated in the generation step to a mobile terminal associated with an authentication-target user; and
an authentication step of authenticating the user when the password is input after the password is generated in the generation step.
